(19) United States
(12) Patent Application Publication
(10) Pub. No.: US 2005/0268226 A1
(43) Pub. Date: Dec. 1, 2005

(54) Method and system for displaying image information

(76) Inventors: Scott E. Lipsky, Seattle, WA (US); Paul Brownlow, Seattle, WA (US)

Correspondence Address: PERKINS COIE LLP;PATENT-SEA, P.O. BOX 1247, SEATTLE, WA, 98111-1247, US

(21) Appl. No.: 10/858,860

(22) Filed: May 28, 2004

(51) Int. Cl. G06F 17/00

(52) U.S. Cl. 715/515; 715/513; 715/517

(57) ABSTRACT

A method and system for displaying image information along with images is provided. An image display system receives an image package that includes images and image descriptions. The image descriptions include image information (or “credits”) and instructions on how the image information is to be displayed. The image display system then displays the images of the received image package and the image information of the image descriptions so that the image information is alpha blended with a portion of the displayed image.

### TECHNICAL FIELD

The described technology relates generally to the presentation of images and particularly to the display of image information along with the images.

### BACKGROUND

The displaying of paintings, sketches, photographs, and other images is very popular in business and personal settings. For example, most homes and offices have paintings or photographs on their walls. It can be very expensive, however, to purchase, maintain, and display high-quality paintings—so much so that most businesses and families cannot afford to do so. As a result, most images that are displayed are low-cost reproductions of high-quality paintings or originals of low-quality paintings. Because viewers can tire of seeing the same painting on a daily basis, some businesses change the locations of the paintings that they display to provide more variety to their customers and employees.

Various electronic means have been used to display images to help reduce the cost of displaying images and increase the variety of images that are displayed. For example, slide programs for general-purpose computers have been developed to display images (e.g., stored in JPEG format) on a display device such as a computer monitor. These slide shows typically cycle through displaying a set of images (e.g., defined by a display list) at a fixed rate. Some electronic frames have been developed that allow a user to upload their own photographs for display on a screen within the frame. These electronic frames can, much like a slide show program, cycle through displaying a set of photographs. It can be a time-consuming process, however, to change the set of images that is displayed either by a slide show program or an electronic picture frame. To change a set of images, a person may have to search for, pay for, and download an electronic version of an image and create a display list that includes that image.

An image distribution system has been developed to distribute images from an image distribution server system to image display client systems. The distribution server periodically distributes packages of images to the image display systems for display on a display device (e.g., a high-resolution, flat-panel monitor).

The distribution of the image packages can be done with little or no user involvement at the image display systems. The images that are distributed by the distribution server are typically licensed from the owner of the original work. When an image is licensed (e.g., from a museum), the licensor may require that certain image information be displayed along with the image. For example, the licensor may require that the artist name, the title of the work, the museum name, and so on be displayed along with the image. In addition, different licensors require that different information be displayed in different ways. For example, one licensor may require that the image information be displayed for 30 seconds when each image is first displayed, and another licensor may require that the image information be displayed for 30 seconds every five minutes that an image is displayed. It would be desirable if the image information could be displayed in an aesthetically pleasing way that does not detract from the display of the image and still meets the requirements of the licensors.

### BRIEF DESCRIPTION OF THE DRAWINGS

FIG. 1 is a block diagram illustrating the display of an image along with its image information in one embodiment.

FIG. 2 is a block diagram illustrating the display of an image along with image information that is horizontally displayed in one embodiment.

FIG. 3 is a timing diagram illustrating timing variables for timing information of an image description in one embodiment.

FIG. 4 is a block diagram illustrating components of the image distribution system in one embodiment.

FIG. 5 is a flow diagram illustrating the processing of the display credits component in one embodiment.

FIG. 6 is a flow diagram illustrating the processing of the alpha blending component in one embodiment.

FIG. 7 is a flow diagram illustrating the processing of a component to create an HTML document with layers in one embodiment.

FIG. 8 is a flow diagram illustrating the processing of the process layer component in one embodiment.

### DETAILED DESCRIPTION

A method and system for displaying image information along with images is provided. In one embodiment, an image display system receives an image package that includes images and image descriptions. The image descriptions include image information (or “credits”) and instructions on how the image information is to be displayed. The image display system then displays the images of the received image package and the image information of the image descriptions so that the image information is alpha blended with a portion of the displayed image. For example, the image description may specify that the image information is to be displayed over the left 20% of the image with an alpha blending weighting factor of 25% for the first 30 seconds that the image is displayed. The alpha blending weighting factor of 25% indicates that the overlay of the image information (i.e., foreground) will result in a 75% transparency of the image (i.e., background). The image description may include a start time, a transition in time, a duration time, and a transition out time. The start time indicates the time during the display of the image at which the image information is to start being displayed. The start time may be indicated relative to the beginning, the ending, or the midpoint of the display of the image. Alternatively, the start time can be specified at any time (or times) within the display of the image. The transition in time indicates the time to transition in the alpha blending of the image information. For example, if the final weighting factor is 50%, then the transition in time indicates the time over which the image information transitions from an initial weighting factor (e.g., 0%) to the final weighting factor. The duration time indicates the time at which the fully alpha blended image information (e.g., at the final weighting factor) is to be displayed. The transition out time indicates the time to transition out the alpha blending of the image information. The image description thus specifies not only the image information but also instructions on how to display the image information. The image description can be used to specify a wide range of formats for the display of image information, which should satisfy the needs of most licensors. In addition, the image description can be tailored to be presented in an aesthetically pleasing manner that minimizes the detraction from the display of the image itself.

In one embodiment, the distribution server distributes image packages to image display systems that have been previously registered. The image packages include image descriptions that specify how image information is to be displayed along with the images within an image information display area. In one embodiment, an image description defines various layers corresponding to the image information display area that specify how image information is to be alpha blended with the underlying image. In addition, the image description may be specified using a markup language document, such as a Hypertext Markup Language (“HTML”) document or an extensible Markup Language (“XML”) document, that is annotated with alpha blending information. The image display systems may then display the image information using a standard markup language render component and applying the alpha blending separately. In addition, the image descriptions may be created using a standard markup language creation component along with a mechanism to annotate the layers.

Table 1 is an example portion of an XML document that provides instructions on how to display image information. The “credit” tag defines the instructions. The “credititem” tag defines the display of a single occurrence of the display image information. The credititem type specifies when the information is to be displayed, such as at the beginning, in the middle, at the end, or at various intervals during the display of the image. The credititem duration specifies the length of time that the information is displayed. The “crediftransition” tag defines how to transition the information. The credittransition direction specifies whether the transition is to be in or out. The credittransition duration specifies the duration of the transition. The credittransition type specifies the type of transitioning such as cross fade. The instructions of Table 1 specify that two occurrences of the display image information are to be displayed as indicated by the two credititem elements. The first credititem element indicates that the first display is to be at the beginning of the display of the image for a duration of 10 seconds. The first credittransition element specifies that the information is to be transitioned in over a duration of 5 seconds using cross fade transitioning. The second credittransition element specifies that the information is to be transitioned out over a duration of 5 seconds using cross fade transitioning. The overall duration is 20 seconds (i.e., 5 seconds transition in, 10 seconds display, 5 seconds transition out). The second credititem element specifies a similar occurrence of the display, except at the end of the display of the image.

TABLE 1

<credit>

<credititem type=beginning duration=10>

<credittransition direction=in type=Xfade duration=5/>
<credittransition direction=out type=Xfade duration=5/>

</credititem>
<credititem type=ending duration=10>

<credittransition direction=in type=Xfade duration=5/>
<credittransition direction=out type=Xfade duration=5/>

</credititem>

</credit>

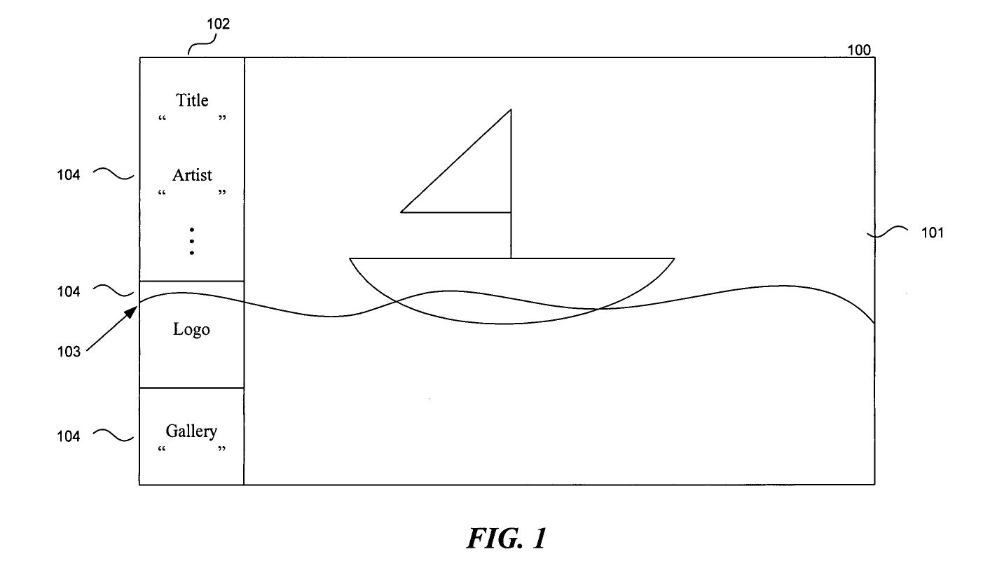

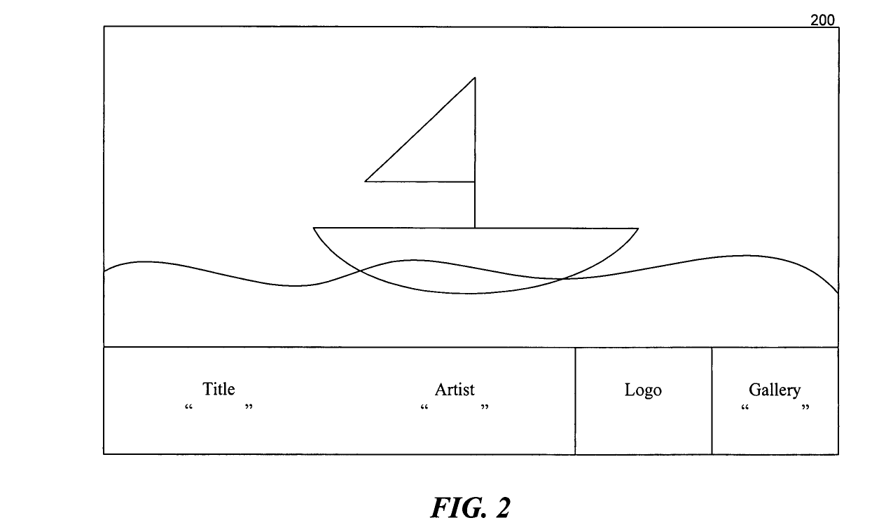

FIG. 1 is a block diagram illustrating the display of an image along with its image information in one embodiment. The display screen 100 includes image 101 and image information display area 102. In this example, the image is transparent through the image information display area as indicated by the waterline 103. The image information display area includes three layers 104. Each layer may specify a different alpha blending weighting factor that indicates how the image is to be visible through the image information display area. FIG. 2 is a block diagram illustrating the display of an image along with image information that is horizontally displayed in one embodiment. One skilled in the art will appreciate the image information display area may be aligned vertically at the left or right of the image or horizontally at the top or bottom of the image. More generally, the image information display area may have an arbitrary position and shape that overlays the image. For example, the information display area may initially cover the entire image with no transparency (i.e., weighting factor of 100%) and may transition to a weighting factor of 0% over a 30-second interval.

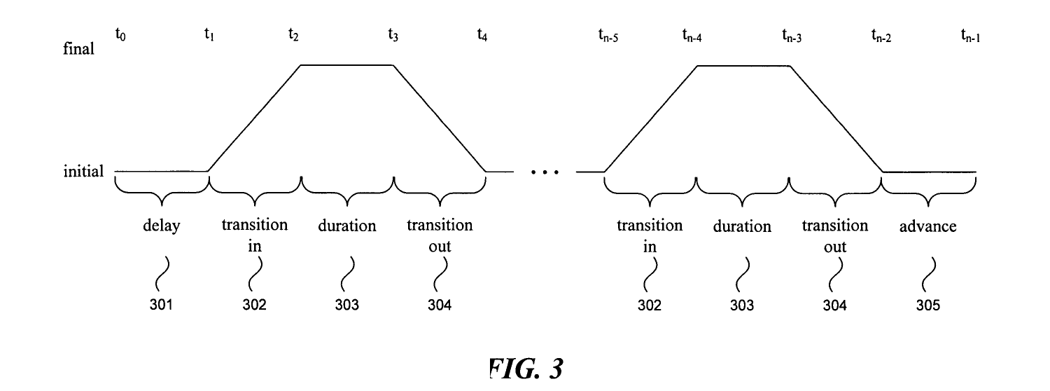

FIG. 3 is a timing diagram illustrating timing variables for timing information of an image description in one embodiment. In this example, the image is displayed starting at time to and continuing until time tₙ₋₁. The image is thus displayed for n time intervals. The delay time 301 indicates the time that the display of the image information is delayed from the start of the display of the image. The transition in time 302 indicates the time to transition in the image information from an initial alpha blending weighting factor to the final weighting factor. The duration time 303 indicates the time that the image information will be displayed at its final weighting factor. The transition out time 304 indicates the time to transition out the image information from the final weighting factor to the initial weighting factor. The advance time 305 indicates the time from the end of the display of the image that the image information should be displayed. The time from the start of transition in to the end of transition out corresponds to the display of one occurrence of the image information. Although the times have been illustrated as having a constant interval, the intervals can vary significantly. For example, the transition in time can be much shorter than the duration time, and the duration time can vary from occurrence to occurrence. In addition, an image description can specify a frequency at which image information is to be displayed (e.g., every five minutes for 30 seconds), the number of times the image information is to be displayed during the display of the image (e.g., five times for 30 seconds), or a set of arbitrarily defined times during the display of the image (e.g., at time zero for 30 seconds, at time five minutes for 60 seconds, at time eight minutes for 25 seconds, and so on).

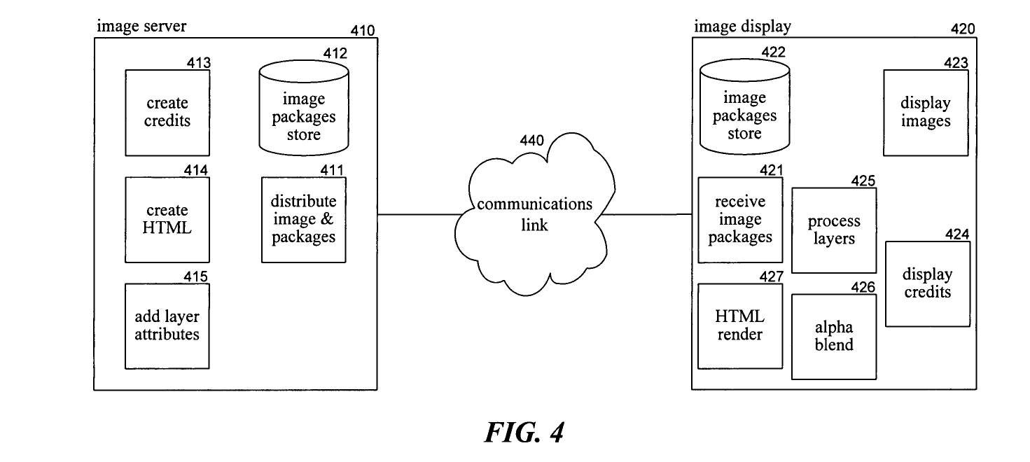

FIG. 4 is a block diagram illustrating components of the image distribution system in one embodiment. The image distribution system includes an image distribution server system 410 and image display client systems 420 interconnected via a communications link 440, such as the Internet. The distribution server includes a distribute image packages component 411, an image packages store 412, a create credits component 413, a create HTML component 414, and an add layer attributes component 415. The distribute image packages component is used to distribute image packages to the image display systems. The image packages store contains image packages that are ready to be distributed. The create credits component is used to define the image descriptions that are to be included in the image packages. The create credits component invokes the create HTML component to define the image information using a standard HTML create component. The create credits component uses the add layer attributes component to add alpha blending weighting factor attributes to the created HTML documents. The image display systems include a receive image packages component 421, an image packages store 422, a display images component 423, a display credits component 424, a process layers component 425, an alpha blending component 426, and an HTML render component 427. The receive image packages component receives image packages via the communications link and stores the image packages in the image packages store. The display images component retrieves the image packages from the image packages store and displays the images in accordance with the image plan included in the image packages. The image plan may specify the sequence and timing of images that are to be displayed. The display credits component is invoked by the display images component to effect the display of image information. The display credits component uses the process layers component to process each layer of the image description and the alpha blending component to effect the alpha blending. The display credits component also uses the HTML render component to render each layer.

The client systems and server system may include a central processing unit, memory, input devices (e.g., keyboard and pointing devices), output devices (e.g., display devices), and storage devices (e.g., disk drives). The memory and storage devices are computer-readable media that may contain instructions that implement the image distribution system. In addition, the data structures and message structures may be stored or transmitted via a data transmission medium such as a signal on a communications link. Various communications links, other than the Internet, may be used such as a local-area network, a wide-area network, or a point-to-point dial-up connection.

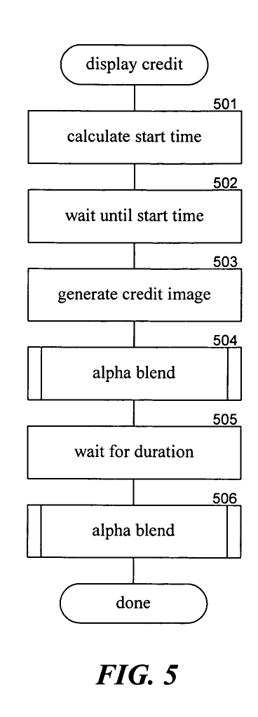

FIG. 5 is a flow diagram illustrating the processing of the display credits component in one embodiment. In this example, the component controls the display of one occurrence of image information. In block 501, the component calculates the start time from the image description. In block 502, the component waits until that start time. In block 503, the component generates the credit image that contains the image information. In block 504, the component invokes an alpha blending component to transition in the credit image onto the displayed image. The alpha blending component is passed an indication of the credit image, where to display the credit image, the start and final alpha blending weighting factors, an increment factor, and a transition time, which are all derived from the image description of the image package. In block 505, the component waits for the duration time of the occurrence. In block 506, the component invokes the alpha blending component to transition out the credit image. The component then completes.

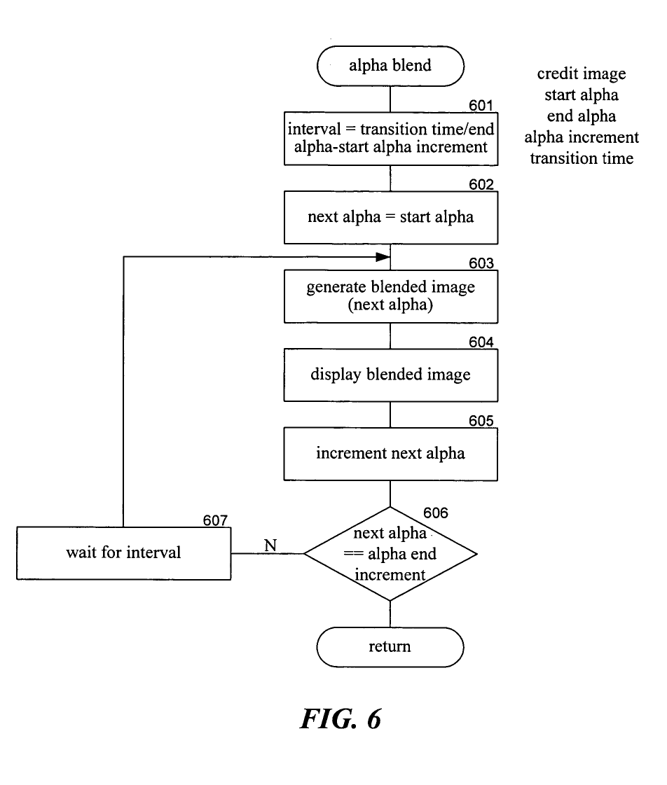

FIG. 6 is a flow diagram illustrating the processing of the alpha blending component in one embodiment. The component is passed the credit image along with information indicating where to display the credit image, the start weighting factor, the final weighting factor, the factor increment, and the transition time. The factor increment indicates how much the weighting factor is to change from one transition to the next. The component blends in the credit image over the passed transition time. In block 601, the component calculates the interval at which each new alpha blended image is to be displayed. In this example, the interval is calculated as the transition time divided by the final weighting factor minus the initial weighting factor divided by the factor increment. For example, if the initial weighting factor is 50% and the final weighting factor is 0%, the factor increment is negative 5%, and the transition time is 30 seconds, then the interval is 3 seconds, which means that every 3 seconds the image information is displayed with its weighting factor reduced by 5%. In block 602, the component sets the next weighting factor to the initial weighting factor. In blocks 603-607, the component loops alpha blending the credit image. In block 603, the component generates a blended image based on the next weighting factor. In one embodiment, the credit information and the image are blended using the following formula:
r,g,b]_{blended}=α[r,g,b]_{credit}+(1+α)[r,g,b]_{image}
where r, g, and b correspond to the red, green, and blue components of a pixel and α corresponds to the next weighting factor. In block 604, the component displays the blended image. In block 605, the component increments to the next weighting factor. In decision block 606, if the next weighting factor is equal to the final weighting factor plus the increment, then the transition is complete and the component returns, else the component continues at block 607. In block 607, the component waits for the interval to pass and then loops to block 603 to alpha blend using the next weighting factor.

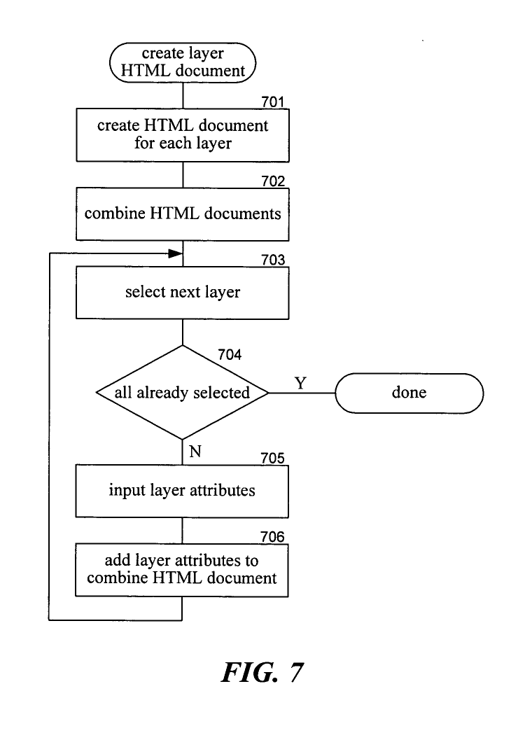

FIG. 7 is a flow diagram illustrating the processing of a component to create an HTML document with layers in one embodiment. In block 701, the component creates an HTML document for each layer of the image credit. The component may use a conventional HTML render component to create the documents. In block 702, the component combines the HTML documents into a single HTML document with a layer for each combined document. In blocks 703-706, the component loops allowing a user to specify the attributes of each layer. In block 703, the component selects the next layer. In decision block 704, if all the layers have already been selected, then the component completes, else the component continues at block 705. In block 705, the component inputs the layer attributes (e.g., alpha blending weighting factor). In block 706, the component adds the attributes to the combined HTML document and loops to block 703 to select the next layer.

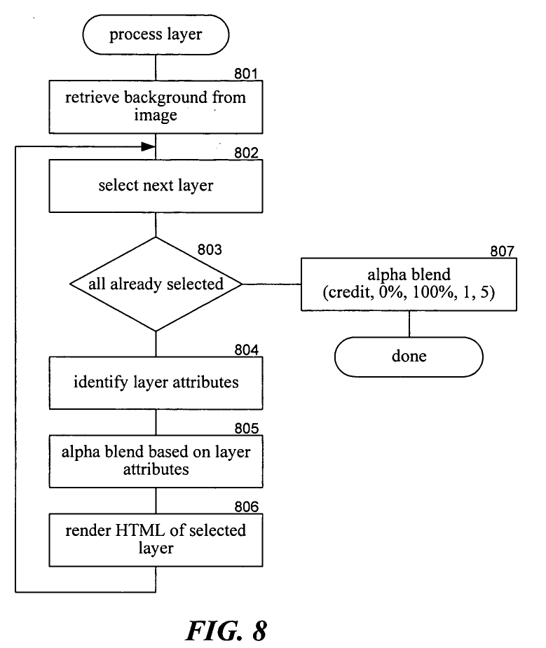

FIG. 8 is a flow diagram illustrating the processing of the process layer component in one embodiment. The component processes each layer in sequence. The component initially retrieves the portion of the image corresponding to the image information display area as the initial content of the display area. The component then applies the instructions of the first layer to the initial content. For example, the first layer may be defined as the upper half of the display area and the instructions may be to render an HTML document and then alpha blend the document with the initial content of the display area. The component then applies the instructions of the second layer which may relate to presenting a logo in the lower half of the display area. One skilled in the art will appreciate that layers can be defined to overlap to achieve various display effects. In block 801, the component retrieves the background portion from the image corresponding to the image information display area. In block 802, the component selects the next layer of the image description. In decision block 803, if all the layers have already been selected, then the component continues at block 807, else the component continues at block 804. In block 804, the component identifies the attributes of the selected layer. In block 805, the component alpha blends based on the layer attributes. In block 806, the component renders the HTML of the selected layer using a conventional HTML render component. The component then loops to block 802 to select the next layer. In block 807, the component invokes the alpha blending component to blend in the credit information. The component then completes.

One skilled in the art will appreciate that although specific embodiments of the image distribution system have been described herein for purposes of illustration, various modifications may be made without deviating from the spirit and scope of the invention. For example, the image description can specify that the credit information is to be displayed in ways that do not use alpha blending. In one embodiment, the credit information may be displayed on a solid background color that is derived from the image itself. For example, the background color may be the average color of the image. Also, each layer may specify different timing information to achieve, for example, different transitioning in and out of credit information. Also, the image information may include a link (e.g., to a web page) to provide additional information relating to the image. Accordingly, the invention is not limited except by the appended claims.

1. A method in a computer system for displaying image information for an image, the method comprising:
receiving an image package that includes an image and an image description, the image description indicating how image information is to be displayed;
displaying the image of the received image package; and
displaying the image information of the image description of the received image package wherein the image information is alpha blended with a portion of the displayed image.

2. The method of claim 1 wherein the image description includes timing information for display of the image information.

3. The method of claim 2 wherein the timing information indicates a start time, a transition in time, a duration time, and a transition out time.

4. The method of claim 3 wherein the start time is specified relative to the start of the displaying of the image.

5. The method of claim 3 wherein the start time is specified relative to the end of the displaying of the image.

6. The method of claim 3 wherein the start time is specified relative to the midpoint of the displaying of the image.

7. The method of claim 2 wherein the timing information indicates that the image information is displayed multiple times during the displaying of the image.

8. The method of claim 7 wherein the timing information indicates the frequency at which the image information is displayed.

9. The method of claim 7 wherein the timing information indicates number of times the image information is displayed during the displaying of the image.

10. The method of claim 1 wherein the image description indicates a width that is a percent of a display area.

11. The method of claim 1 wherein the image description indicates a width that is a percent of the image area.

12. The method of claim 1 wherein the image description indicates that the image information is arranged vertically.

13. The method of claim 1 wherein the image description indicates that the image information is arranged horizontally.

14. The method of claim 1 wherein the image description includes an alpha blending weighting factor.

15. The method of claim 1 wherein the image information includes artist, title, and year.

16. The method of claim 1 wherein the image information includes a link to more information about the image.

17. The method of claim 16 wherein the link is a uniform resource locator.

18. The method of claim 1 wherein the image information is stored in a markup language document.

19. The method of claim 18 wherein the document includes multiple layers with layer attributes for displaying the image information.

20. The method of claim 19 wherein the document can be rendered using a standard markup language render component.

21. The method of claim 19 wherein a layer has an associated alpha blending weighting factor that applies to the portion of the image description associated with that layer.

22. A method for displaying of images along with image information, the method comprising:
providing an indication of display systems that are registered to display images;
preparing image packages that include images and an image plan, the image plan including an image description with image information;
distributing the image packages to the registered display systems; and
displaying at the registered display systems the images of the distributed image packages in accordance with the image plan and along with the image information of the image description.

23. The method of claim 22 wherein the image description specifies an alpha blending weighting factor for alpha blending of the image information with the image.

24. The method of claim 22 wherein the image information is displayed with a background that is derived from the image.

25. The method of claim 24 wherein the color of the background is the average color of the image.

26. The method of claim 22 wherein the image description is specified using an HTML document along with an alpha blending weighting factor.

27. The method of claim 22 wherein the image description specifies transparency level when the image information is displayed.

28. The method of claim 22 wherein the image descriptions are distributed to the registered display systems and displayed without user intervention at the registered display systems.

29. A computer-readable medium containing instructions for controlling a computer system to display image information for an image, by a method comprising:
displaying an image of an image package, the image package having the image and an image description, the image description indicating how image information is to be displayed; and
displaying the image information of the image description of the image package.

30. The computer-readable medium of claim 29 wherein the image information is alpha blended with a portion of the displayed image.

31. The computer-readable medium of claim 29 wherein the image description includes timing information for display of the image information.

32. The computer-readable medium of claim 31 wherein the timing information indicates a start time, a transition in time, a duration time, and a transition out time.

33. The computer-readable medium of claim 32 wherein the start time is specified relative to the start of the displaying of the image.

34. The computer-readable medium of claim 32 wherein the start time is specified relative to the end of the displaying of the image.

35. The computer-readable medium of claim 32 wherein the start time is specified relative to the midpoint of the displaying of the image.

36. The computer-readable medium of claim 31 wherein the timing information indicates that the image information is displayed multiple times during the displaying of the image.

37. The computer-readable medium of claim 29 wherein the image description indicates a width that is a percent of a display area.

38. The computer-readable medium of claim 29 wherein the image description includes an alpha blending weighting factor.

39. The computer-readable medium of claim 29 wherein the image information includes artist, title, and year.

40. The computer-readable medium of claim 29 wherein the image information includes a link to more information about the image.
